(19) United States
(12) Patent Application Publication
(10) Pub. No.: US 2010/0033467 A1
(43) Pub. Date: Feb. 11, 2010

(54) DC-DC CONVERTER AND ORGANIC LIGHT EMITTING DISPLAY DEVICE USING THE SAME

(76) Inventor: Sung-Cheon Park, Yongin-City (KR)

Correspondence Address: CHRISTIE, PARKER & HALE, LLP, PO BOX 7068, PASADENA, CA, 91109-7068, US

(21) Appl. No.: 12/536,352

(22) Filed: Aug. 5, 2009

(30) Foreign Application Priority Data
Aug. 6, 2008 (KR) 10-2008-0076939

(51) Int. Cl. G05F 5/00; G06F 3/038

(52) U.S. Cl. 345/211; 307/31

(57) ABSTRACT

A DC-DC converter with improved efficiency achieved by controlling a voltage of a power supply transmitted to an organic light emitting diode in accordance with a voltage of a battery, and an organic light emitting display device using the same. A DC-DC converter according to one embodiment includes a voltage detecting unit for detecting a voltage of a battery, a booster circuit for receiving and boosting the input voltage to generate and output a first power, and an inverter circuit for receiving and inverting the input voltage to generate and output a second power, where the voltage of the second power is controlled and output corresponding to the input voltage detected by the voltage detecting unit.

### CROSS-REFERENCE TO RELATED APPLICATIONS

This application claims priority to and the benefit of Korean Patent Application No. 10-2008-0076939, filed on Aug. 6, 2008, in the Korean Intellectual Property Office, the entire content of which is incorporated herein by reference.

### BACKGROUND OF THE INVENTION

1. Field of the Invention

The present invention relates to a DC-DC converter and an organic light emitting display device using the same, and more particularly to a high efficiency DC-DC converter and an organic light emitting display device using the same.

2. Description of Related Art

Recently, various flat panel displays having less weight and volume than cathode ray tubes (CRTs) have been developed. Some examples of flat panel displays include liquid crystal displays, field emission displays, plasma display panels, and organic light emitting displays, to name but a few.

Among others, organic light emitting displays display images using organic light emitting diodes (OLEDs) that generate light by a recombination of electrons and holes generated corresponding to the flow of an electric current.

Because organic light emitting displays have various advantages, such as excellent color reproducibility, thin profile, etc., their market has expanded into a variety of applications, e.g., portable digital assistants (PDAs), MP3 players, or the like, in addition to cellular phones.

FIG. 1 is a circuit diagram illustrating a pixel circuit of a conventional organic light emitting display device. The organic light emitting display device of FIG. 1 may be applied to embodiments of the present invention. Referring to FIG. 1, the pixel is coupled to a data line Dm and a scan line Sn, and includes a first transistor M1 for driving the organic light emitting diode, a second transistor M2 for switching a data signal, a capacitor Cst for storing the data signal, and an organic light emitting diode OLED.

A source of the first transistor M1 is coupled to a first power supply ELVDD, a drain thereof is coupled to an anode electrode of the organic light emitting diode OLED, and a gate thereof is coupled to a first node N1. A source of the second transistor M2 is coupled to the data line Dm, a drain thereof is coupled to the first node N1, and a gate thereof is coupled to the scan line Sn. A first electrode of the capacitor Cst is coupled to the first power supply ELVDD, and a second electrode thereof is coupled to the first node N1. An anode electrode of the organic light emitting diode OLED is coupled to the drain of the first transistor M1 and a cathode electrode thereof is coupled to a second power supply ELVSS.

In the pixel, the voltage of the first node N1 corresponds to the data signal transmitted through the data line Dm, and the first transistor M1 drives a current from the first power supply ELVDD to the second power supply ELVSS according to the voltage of the first node N1. With this operation, the organic light emitting diode OLED emits light.

The first power ELVDD and the second power ELVSS transmitted to the pixel are typically generated by a booster circuit and an inverter circuit, respectively, wherein the booster circuit and the inverter circuit have properties that they decrease in efficiency if a difference between input voltage and output voltage is great. By way of example, as it requires more power to generate 4.6V from a 2.9V input, than to generate 4.6V from a 4.2V input, operational efficiency is deteriorated. Therefore, if an input voltage from a battery falls below a predetermined value, the booster circuit and the inverter circuit may stop operations due to the decrease in efficiency, causing a problem in that the time of use of the battery is shortened.

### SUMMARY OF THE INVENTION

An aspect of exemplary embodiments of the present invention provides a DC-DC converter with improved efficiency by varying a voltage of a base power supply transmitted to an organic light emitting diode, and an organic light emitting display device using the same.

According to a first embodiment of the present invention a DC-DC converter includes a voltage detector for detecting an input voltage, a booster for receiving and boosting the input voltage to generate and output a first power, and an inverter for receiving and inverting the input voltage to generate and output a second power. A voltage of the second power is controlled and output according to the input voltage detected by the voltage detector.

According to a second embodiment of the present invention, an organic light emitting display device includes a display unit for displaying an image corresponding to a data signal, a scan signal, a first power, and a second power. A data driver generates and outputs the data signal. A scan driver generates and outputs the scan signal. A DC-DC converter generates the first power and second power, wherein the DC-DC converter includes a voltage detector for detecting an input voltage, a booster for receiving and boosting the input voltage to generate and output the first power, and an inverter for receiving and inverting the input voltage to generate and output the second power, the second power being controlled and output in accordance with the input voltage detected by the voltage detector.

In an organic light emitting display utilizing a DC-DC converter according to an embodiment of the present invention, the voltage of a second power supply output from the DC-DC converter is controlled according to the voltage of a battery, thereby reducing power consumption in the organic light emitting display device.

### BRIEF DESCRIPTION OF THE DRAWINGS

The accompanying drawings together with the specification illustrate exemplary embodiments of the present invention, and, together with the description, serve to explain the principles of the present invention.

FIG. 1 is a schematic circuit diagram illustrating a circuit adapted for a conventional organic light emitting display device;

FIG. 2 is a block diagram of an organic light emitting display device according to an exemplary embodiment of the present invention;

FIG. 3 is a block diagram illustrating a DC-DC converter according to an exemplary embodiment of the present invention; and

FIG. 4 is a circuit diagram illustrating an example of the DC-DC converter of FIG. 3.

### DETAILED DESCRIPTION

Hereinafter, certain exemplary embodiments according to the present invention will be described with reference to the accompanying drawings. Herein, when a first element is described as being coupled to a second element, the first element may be directly coupled to the second element, or may be indirectly coupled to the second element via a third element. Further, some of the elements that are not essential to a complete understanding of the invention are omitted for clarity. Also, like reference numerals refer to like element throughout.

FIG. 2 is a block diagram of an organic light emitting display device according to an exemplary embodiment of the present invention. Referring to FIG. 2, the organic light emitting display device includes a display unit 100, a data driver 200, a scan driver 300, and a DC-DC converter 400.

The display unit 100 includes a plurality of pixels 101, each of which includes an organic light emitting diode (OLED, not shown) adapted to emit light corresponding to a flow of current through the OLED. Also, the display unit 100 is formed with n scan lines (S1, S2, . . . , Sn-1, and Sn) extending in a row direction for sending scan signals, and m data lines (D1, D2, . . . , Dm-1, and Dm) extending in a column direction for sending data signals.

The display unit 100 receives and is driven by the first power ELVDD and the second power ELVSS. Therefore, the display unit 100 emits light by causing a current to flow through the organic light emitting diodes in response to the scan signals, the data signals, the first power ELVDD, and the second power ELVSS, thereby displaying an image.

The data driver 200 generates data signals using image signals R, G, and B data having red, blue, and green components, respectively. The data driver 200 is coupled to the data lines D1, D2, . . . , Dm-1, and Dm to apply the data signals to the display unit 100.

The scan driver 300, which generates the scan signals, is coupled to the scan lines S1, S2, . . . , Sn-1, and Sn to send the scan signals to a specific row of the display unit 100. A pixel 101 selected with the scan signal receives a voltage corresponding to the data signal transmitted from the data driver 200.

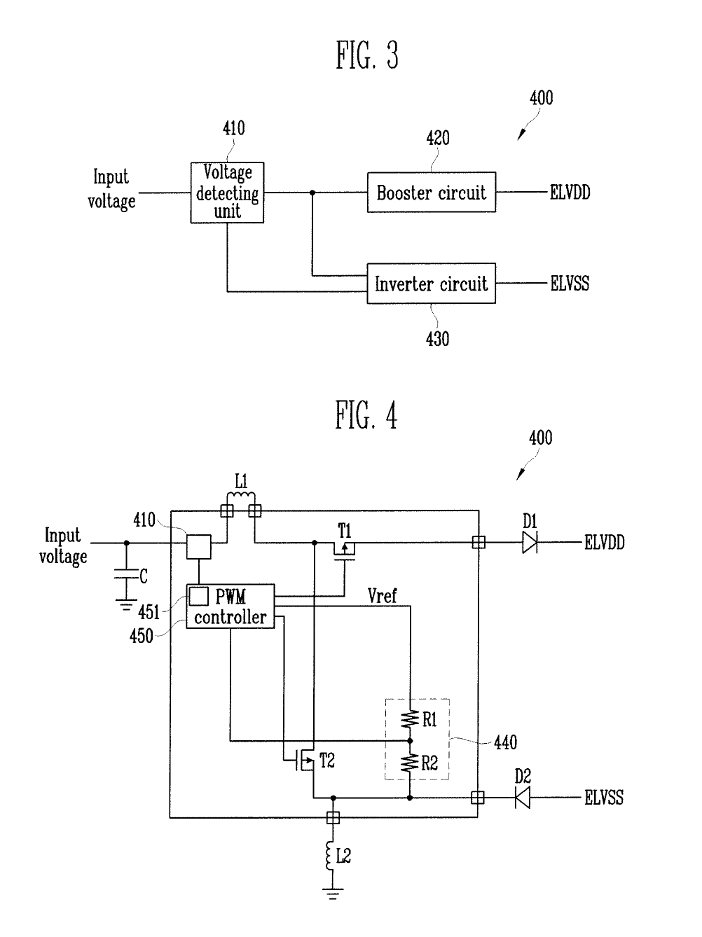

The DC-DC converter 400 receives an input current and an input voltage from the battery, and generates first power ELVDD and second power ELVSS. As illustrated in FIG. 3, the DC-DC converter 400 includes a booster circuit (or booster) 420 and an inverter circuit (or inverter) 430, wherein the booster circuit 420 boosts the input voltage to generate the first power ELVDD, and the inverter circuit 430 inverts the input voltage to generate the second power ELVSS. The booster circuit 420 and the inverter circuit 430 generally have better efficiency when a difference between their input voltage and their output voltage is small. In general, the input voltage from the battery gradually lowers as time elapses. That is, as the current from the battery is output during use of the battery, the input voltage of the booster circuit 420 and the inverter circuit 430 lowers. Therefore, as the input voltage is lowered, the booster circuit 420 and the inverter circuit 430 tend to deteriorate in efficiency.

In order to address this issue, the DC-DC converter 400 further includes a voltage detecting unit 410 for sensing an electric potential of the input voltage. The voltage detecting unit 410 senses the input voltage and the DC-DC converter 400 controls the voltage of at least the second power supply ELVSS corresponding to the sensed voltage level. In other words, the output voltage of the inverter circuit 430 is controlled in accordance with the input voltage of the inverter circuit 430, such that the efficiency of the DC-DC converter 400 improves.

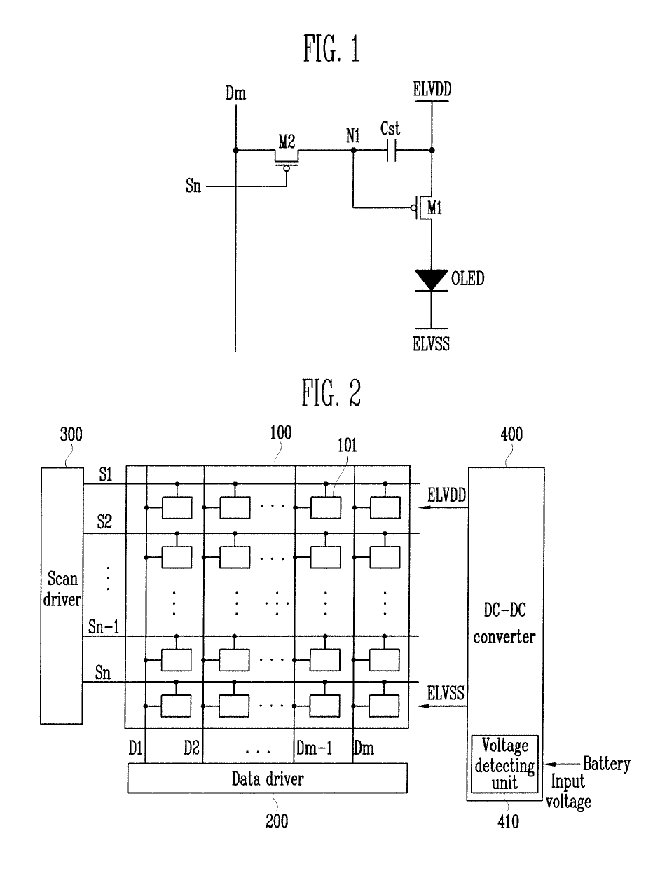

The voltage of the second power supply ELVSS enables the organic light emitting diodes to be driven in a saturation region, wherein the conditions to drive the organic light emitting diodes in the saturation region may change according to the materials in the organic film of the organic light emitting diode and properties of the driving transistor (e.g., the first transistor M1 in FIG. 1). Therefore, when designing an organic light emitting display device, the voltage of the second power supply ELVSS generally has a margin of about 2 to 3V, so that the desired image can be sufficiently displayed even under unfavorable conditions. When designing the organic light emitting display device, if the voltage of the second power supply ELVSS is fixed, an absolute value of the voltage of the second power supply ELVSS is designed to be large. If the absolute value of the voltage of the second power supply ELVSS is designed to be large (for example, −5.4V) as described above, the input voltage of the battery should be set to be large. However, if the absolute value of the voltage of the second power supply ELVSS is designed to be small (for example, −3.4V), the input voltage of the battery is set to be low, enabling a reduction in consumption of the power from the battery. Therefore, after setting the input voltage to be low, if the voltage of the second power supply ELVSS is controlled as time elapses, the efficiency of the DC-DC converter 400 improves.

FIG. 3 is a block diagram showing a DC-DC converter according to an exemplary embodiment of the present invention. Referring to FIG. 3, the DC-DC converter 400 includes a voltage detecting unit (or voltage detector) 410, a booster circuit (or booster) 420, and an inverter circuit (or inverter) 430.

The voltage detecting unit 410 receives and measures an input voltage from a battery. The booster circuit 420 boosts the input voltage from the battery to generate the first power ELVDD. The inverter circuit 430 inverts the input voltage from the battery to generate the second power ELVSS. The inverter circuit 430 also controls the voltage of the second power ELVSS in accordance with the input voltage detected by the voltage detecting unit 410. In other words, when the measured input voltage is high, the inverter circuit 430 increases an absolute value of the voltage of the second power ELVSS, and when the measured input voltage is low, the inverter circuit 430 reduces an absolute value of the voltage of the second power ELVSS.

FIG. 4 is a circuit diagram illustrating an exemplary embodiment of the DC-DC converter 400 of FIG. 3. One skilled in the art will comprehend that different components may be used to generate output voltages, such as a switch-mode converter, a buck converter, a boost converter, a buck-boost converter, or any other suitable configuration known to those skilled in the art. Referring to FIG. 4, the DC-DC converter 400 includes a capacitor C for charging an input current, and to be charged with a voltage (e.g., a predetermined voltage), a voltage detecting unit 410 for determining the input voltage, a first coil L1 for generating the first power ELVDD according to an increase or a decrease in the input voltage to boost the input voltage, a first switching device (or switch) T1 enabling the input current to be transmitted to or blocked from the first coil L1 so that the first coil L1 generates the first power ELVDD, a second switching device (or switch) T2 coupled to the first switching device T1 for sending or blocking the flow of the input current transmitted through the first coil L1, a second coil L2 coupled to the second switching device T2 for generating the second power ELVSS by sending or blocking the input current transmitted through the second switching device T2, a Vref varying circuit 440 for varying a reference voltage Vref, first and second resistors R1 and R2 coupled between the Vref varying circuit 440 and the second coil L2 for dividing a voltage between the reference voltage Vref and the second power ELVSS, and a pulse width modulation (PWM) controller 450 for controlling switching operations of the first and second switching devices T1 and T2. The PWM controller 450 is further coupled between the first resistor R1 and second resistor R2 to undergo feedback of the divided voltage, thereby enabling control of the switching of the switching devices T1 and T2 in accordance with the divided voltage between the reference voltage Vref and the second power ELVSS.

The Vref varying circuit 440 receives a voltage (e.g., a predetermined voltage) Vref to vary the voltage thereof. By way of example, there is a method for varying a voltage through a voltage division.

The PWM controller 450 includes a lookup table 451 in which a voltage correction range of the reference voltage Vref is stored, corresponding to the voltage of the input current, an example of which is shown in Table 1 below. By utilizing this lookup table, when the voltage of the input current sensed by the voltage detecting unit 410 is measured, the PWM controller 450 corrects the reference voltage Vref using the lookup table. Therefore, the voltage of the second power supply ELVSS is controlled in correspondence to the corrected reference voltage Vref. One skilled in the art will comprehend that the values in this particular lookup table 451 are not limiting, and are only intended as an example. Other suitable values may be stored in the lookup table 451.

TABLE 1

| | Vin (Measured Values) | Vref | ELVSS |
|---|---|---|---|
| 1 | 4.2 < Vin <= 4.5 V | Vref + 1 | −5.5 V |
| 2 | 2.9 < Vin <= 4.2 V | Vref | −5.1 V |
| 3 | 2.7 < Vin <= 2.9 V | Vref − 1 | −4.6 V |
| 4 | 2.5 < Vin <= 2.7 V | Vref − 2 | −4.1 V |
| 5 | 2.3 < Vin <= 2.5 V | Vref − 3 | −3.6 V |
| 6 | 2.1 < Vin <= 2.3 V | Vref − 4 | −3.1 V |

While the present invention has been described in connection with certain exemplary embodiments, it is to be understood that the invention is not limited to the disclosed embodiments, but, on the contrary, this disclosure is intended to cover various modifications and equivalent arrangements included within the spirit and scope of the appended claims, and equivalents thereof.

What is claimed is:

1. A DC-DC converter comprising:
a voltage detector for detecting an input voltage;
a booster for receiving and boosting the input voltage to generate and output a first power; and
an inverter for receiving and inverting the input voltage to generate and output a second power, a voltage of the second power being controlled and output in accordance with the input voltage detected by the voltage detector.

2. The DC-DC converter as claimed in claim 1, wherein the booster comprises:
a first coil coupled to an input terminal to which the input voltage is transmitted; and
a first switch for performing a switching operation corresponding to the input voltage to enable the input voltage to drive or block a current through the first coil so that the first power is generated in the first coil.

3. The DC-DC converter as claimed in claim 2, wherein the inverter comprises:
a second switch for switching a first voltage of the first coil in accordance with the input voltage;
a second coil to which the first voltage is transmitted or blocked by the switching of the second switch; and
first and second resistors for dividing a voltage between a reference voltage and a voltage generated by the second coil.

4. The DC-DC converter as claimed in claim 3 further comprising:
a pulse width modulation (PWM) controller coupled to the first switch and the second switch to control the switching of the first switch and second switch.

5. The DC-DC converter as claimed in claim 4, wherein the PWM controller is coupled between the first and second resistors for receiving a feedback voltage, the feedback voltage corresponding to the divided voltage between the reference voltage and the voltage generated by the second coil, wherein the PWM controller is configured to control a pulse width of an output signal of the PWM controller in accordance with the feedback voltage.

6. The DC-DC converter as claimed in claim 4, wherein the PWM controller further comprises a lookup table for storing variation values of the reference voltage in accordance with the input voltage.

7. The DC-DC converter as claimed in claim 1, wherein the input voltage is from a battery.

8. The DC-DC converter as claimed in claim 1, wherein the inverter comprises a switch-mode circuit.

9. The DC-DC converter as claimed in claim 1, wherein the second power is lower than a ground voltage.

10. An organic light emitting display device comprising:
a display unit for displaying an image corresponding to a data signal, a scan signal, a first power and a second power;
a data driver for generating and outputting the data signal;
a scan driver for generating and outputting the scan signal; and
a DC-DC converter for generating the first power and the second power,
wherein the DC-DC converter comprises:
a voltage detector for detecting an input voltage;
a booster for receiving and boosting the input voltage to generate and output the first power; and
an inverter for receiving and inverting the input voltage to generate and output the second power, the second power being controlled and output in accordance with the input voltage detected by the voltage detector.

11. The organic light emitting display device as claimed in claim 10, wherein the booster comprises:
a first coil coupled to an input terminal to which the input voltage is transmitted; and
a first switch for switching in accordance with the input voltage to enable the input voltage to drive or block a current through the first coil.

12. The organic light emitting display device as claimed in claim 11, wherein the inverter comprises:
a second switch for switching an input voltage of the first coil in accordance with the input voltage;
a second coil to which the input voltage is transmitted or blocked by the switching of the second switch; and
first and second resistors for dividing a voltage between a reference voltage and a voltage generated by the second coil.

13. The organic light emitting display device as claimed in claim 12, further comprising:
a PWM controller coupled to the first switch and the second switch to control the first switch and the second switch.

14. The organic light emitting display device as claimed in claim 13, wherein the PWM controller is coupled between the first and second resistors for receiving a feedback voltage, the feedback voltage corresponding to the divided voltage between the reference voltage and the voltage generated by the second coil, wherein the PWM controller is configured to control a pulse width of an output signal of the PWM controller in accordance with the feedback voltage.

15. The organic light emitting display device as claimed in claim 13, wherein the PWM controller further comprises a lookup table for storing variation values of the reference voltage corresponding to the input voltage.

16. The organic light emitting display device as claimed in claim 10, wherein the input voltage is from a battery.
